(19) United States
(12) Patent Application Publication
(10) Pub. No.: US 2026/0171438 A1
(43) Pub. Date: Jun. 18, 2026

(54) METHOD FOR OPERATING A FUEL CELL SYSTEM

(71) Applicant: Robert Bosch GmbH, Stuttgart (DE)

(72) Inventors: Jochen Braun, Heimsheim (DE); Nicole Bayerle, Schwieberdingen (DE)

(21) Appl. No.: 18/873,385

(22) PCT Filed: May 17, 2023
(86) PCT No.: PCT/EP2023/063259

§ 371 Date: Dec. 10, 2024

(30) Foreign Application Priority Data
Jun. 10, 2022 (DE) 10 2022 205 913.1

(51) Int. Cl. H01M 8/04089; H01M 8/04111; H01M 8/0438; H01M 8/04746

(52) U.S. Cl. CPC H01M 8/04089; H01M 8/04111; H01M 8/04395; H01M 8/0441; H01M 8/04776; H01M 2250/20

(57) ABSTRACT

The invention relates to a method of operating a fuel cell system (1), with a fuel cell stack (2), to which a mass gas flow (4) with an oxidation agent is supplied via a gas conveying system (3), wherein the gas conveying system (3) comprises at least one compressor driven by an electric motor (7,8) having a pumping limit (27) and at least one turbine (12), driven by an exhaust mass flow (14) of the fuel cell stack (2), which comprises a cathode path having a cathode mass flow rate and a cathode pressure, wherein the compressor (7,8) can be driven at a variable speed, wherein the turbine (12) is associated with a turbine bypass (15) with a turbine bypass valve (16), wherein a stack bypass (17) is associated with the fuel cell stack (2) with a stack bypass valve (18), wherein the fuel cell system (1) operates in different operating ranges, in which the cathode mass flow and the cathode pressure are controlled.
To simplify and/or improve operation of the fuel cell system (1), the turbine bypass valve (16) remains closed at high pressure ratios in a first operating range (I) in which the pumping limit (27) of the compressor (7.8) lies, wherein the cathode pressure is controlled via the speed of the compressor (7.8), wherein the cathode mass flow is controlled via the stack bypass valve (18).

### BACKGROUND

The invention relates to a method for operating a fuel cell system, with a fuel cell stack, to which a mass gas flow with an oxidizing agent is supplied via a gas conveying system, wherein the gas conveying system comprises at least one compressor driven by an electric motor having a pumping limit and at least one turbine, which can be driven by an exhaust mass flow of the fuel cell stack, which comprises a cathode path having a cathode mass flow and a cathode pressure, wherein the compressor can be driven at a variable speed, wherein a turbine bypass with a turbine bypass valve is associated with the turbine, wherein a stack bypass with a stack bypass valve is associated with the fuel cell stack, wherein the fuel cell system is operated in different operating ranges, in which the cathode mass flow and the cathode pressure are regulated.

A method for operating a fuel cell system is known from the German patent application DE 10 2019 216 624 A1, with a fuel cell stack, to which a mass gas flow with an oxidizing agent is supplied via a gas conveying system, wherein the gas conveying system comprises a first compressor stage including at least one compressor driven by an electric motor and a second compressor stage comprising a compressor driven by a turbine, which can be driven by an exhaust mass flow of the fuel cell stack, which comprises a cathode path having a cathode mass flow and a cathode pressure, wherein the compressor of the first compressor stage can be driven at a variable speed, wherein the turbine of the second compressor stage is associated with a turbine bypass valve, wherein a stack bypass with a stack bypass valve is associated with the fuel cell stack, wherein a post-stack valve is downstream of the fuel cell stack.

### SUMMARY

The object of the invention is to simplify and/or improve the operation of a fuel cell system according to the disclosure.

The object is solved by a method for operating a fuel cell system according to the disclosure in that the turbine bypass valve remains closed at high pressure ratios in a first operating range in which the pumping limit of the compressor lies, wherein the cathode pressure is regulated via the speed of the compressor, wherein the cathode mass flow is regulated via the stack bypass valve. The claimed method relates to a regulation or control structure with respect to the pressure level in the fuel cell stack and the mass flow through the fuel cell stack. The control structure or regulation may be realized as both a pressure ratio and a pressure, that is, an absolute pressure or a relative pressure. The term pressure, if not otherwise indicated, refers to the cathode pressure in the cathode path. Pressure losses within the cathode path may be measured and/or calculated. The pressure losses measured and/or calculated, for example using a suitable model, can be included in the regulation and/or its pilot control. The cathode pressure regulation is also referred to simply as the as pressure regulation and may also be embodied as pressure ratio regulation, as previously described. A line of separation between the two operating ranges can be considered as a boundary in a Cartesian coordinate diagram in which the pressure or the pressure ratio is plotted via the mass flow. According to the prior art, a pressure regulating valve in the exhaust path, referred to as a post-stack valve, is used to control the cathode pressure in the stack and mass flow in the stack together with other components, in particular the compressor, the stack bypass valve, and the turbine bypass valve. With the claimed method, it is possible to adjust or control a desired mass flow rate in the stack and a desired cathode pressure with the aid of the compressor speed, the turbine bypass valve and the stack bypass valve, namely advantageously without employing a post-stack valve in the exhaust mass flow. The mass flow through the stack can be reduced with the stack bypass valve when the turbine bypass valve is closed. In this case, the pressure is controlled by the speed of the compressor. A characteristic curve at which the speed is plotted over the pressure ratio can be saved as a pilot control. The stack bypass valve is used to control the mass flow. A characteristic curve in which the valve position is plotted over the mass flow reduction of the system characteristic curve can be saved as a pilot control.

A preferred exemplary embodiment of the method is characterized in that the stack bypass valve remains closed in a second operating range, at low pressure ratios, wherein the cathode pressure is controlled via the turbine bypass valve, wherein the cathode mass flow is controlled via the speed of the compressor. A choke line of the compressor serves as the lower limit for the second operating range. A line of separation between the two operating ranges in a Cartesian coordinate diagram, in which the pressures or pressure ratios are plotted over the mass flow, can be considered the limit. In the second operating range, the mass flow is controlled by the compressor speed. The turbine bypass valve is used to control the pressure. The stop limit serves as the lower limit for the second operating range. A characteristic curve for the mass flow over the speed can be stored as a pilot control for the compressor speed. In order to reduce the pressure ratio, a characteristic curve may be stored with the maximum pressure ratio over the speed as well as the pressure ratio of the compressor depending on the speed and a characteristic curve with the percentage reduction of the pressure ratio of the compressor depending on the valve position. On the one hand, the stack bypass operation is extended by the claimed method. In addition, gas conveyance is improved. The throttle characteristic of the gas path downstream of the compressor, in particular the turbine with the turbine bypass, is particularly advantageously optimized. The claimed operating strategy uses the turbine bypass valve primarily to perform pressure regulation in the system. If the control limit is reached, then the pressure regulation is carried out primarily by means of the electrically driven compressor via its speed. As a result, in the prior art, the control valve referred to as the post-stack valve is not necessary in the exhaust path.

Another exemplary embodiment of the method is characterized in that, when the requested cathode mass flow is greater than the achievable mass flow, the system switches from the first to the second operating range via gas conveying system or the air system with the stack bypass valve fully closed. This increases the distance to the pumping limit of the compressor, thereby allowing for more stable operation.

Another exemplary embodiment of the method is characterized in that, when the requested cathode pressure is greater than the achievable pressure by means of the air system with the turbine bypass fully closed, the system switches from the second to the first operating range. This ensures that the entire operating range of the fuel cell system can be utilized. System complexity is reduced. The required design space is reduced.

Another preferred exemplary embodiment of the method is characterized in that hysteresis is used to switch between the two operating ranges. An undesirable shift between operating ranges is referred to as toggling. The hysteresis may be temporal hysteresis, mass flow hysteresis, or pressure range hysteresis.

A further preferred exemplary embodiment of the method is characterized in that the system switches between the two operating ranges with a modified controller request. A modified controller request means that, when there is a jump in the target values, it is possible to read the operating range into which the system changes from the two target variables, i.e. target pressure and target mass flow. Target mass flow is defined as the mass flow through the fuel cell stack that is predetermined as the target value by the controller. The stack mass flow corresponds to the compressor mass flow minus the bypass mass flow.

Another preferred exemplary embodiment of the method is characterized in that a pilot-controlled PID controller is used. Both the controller and the pilot optionally consider a number of input parameters, for example, sensor values from the fuel cell system, values from calculation models of the fuel cell controller, ambient parameters et cetera. This is in particular a stack temperature, an ambient pressure, or a current height above sea level, an ambient temperature et cetera.

A further preferred exemplary embodiment of the method is characterized in that no control valve in a main path is downstream of the fuel cell stack, in particular no post-stack valve as disclosed in the German patent application DE 10 2019 216 624 A1. In a main path here means that, while a control valve may be located in the exhaust path downstream of the fuel cell stack, it may not be located in the main path but only in a bypass. Therefore, no control valve is downstream of the stack in the main path. In particular, no control valve is downstream of the stack upstream or downstream of the turbine. This results in significant cost advantages in manufacturing, with regard to construction space, and with regard to operation of the fuel cell system.

Another preferred exemplary embodiment of the method is characterized in that the fuel cell stack is connected between two shut off valves. The shut off valves are only used to interrupt the connections to the fuel cell stack, for example to perform maintenance operations. The shut off valves are not used to control operation of the fuel cell system.

The present invention further relates to a system for operating a fuel cell system according to a method described above.

The invention also relates, where applicable, to a vehicle with a drive comprising a fuel cell system as described above. The invention also relates, where applicable, to a mobile application or a stationary application with a fuel cell system as described above.

The invention furthermore relates to a computer program product with a computer program that comprises software for performing a method as described above, if the computer program is executed on a programmable computing device. For example, the computing device is a controller of the fuel cell system.

### BRIEF DESCRIPTION OF THE DRAWINGS

Further advantages, features, and details of the invention arise from the following description, in which exemplary embodiments are described in detail with reference to the drawings.

Shown are:

FIG. 1 a schematic illustration of a fuel cell system with two compressor stages;

FIG. 2 a fuel cell system similar to that of FIG. 1 with a compressor driven by an electric motor combined with a turbine in the exhaust mass flow;

FIG. 3 a Cartesian coordinate diagram in which the cathode pressure is plotted over the cathode mass flow, with two operating ranges in which a cathode pressure is regulated without a post-stack valve in an exhaust mass flow;

FIG. 4 a Cartesian coordinate diagram in which the cathode pressure is plotted over the cathode mass flow, with three operating ranges in which a cathode pressure is regulated with, among other things, a conventional post-stack valve in an exhaust mass flow;

FIG. 5 a Cartesian coordinate diagram in which the cathode pressure is plotted over the cathode mass flow, with two arrows illustrating the differences between FIGS. 3 and 4;

FIG. 6 a controller in a first operating range;

FIG. 7 a controller in a second operating range;

FIG. 8 a Cartesian coordinate diagram for regulation in the second operating range;

FIG. 9 a schematic illustration of a possible variant for a pilot-controlled PID controller for the first operating range; and

FIG. 10 a possible variant for a pilot-controlled PID controller for the second operating range.

### DETAILED DESCRIPTION

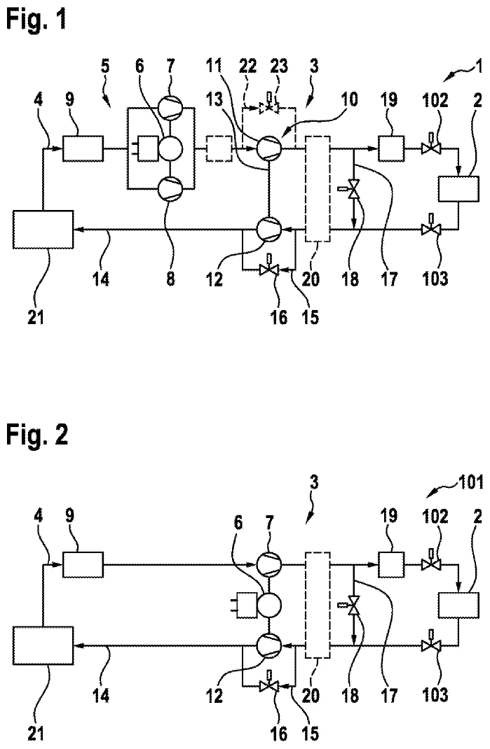

FIGS. 1 and 2 show a fuel cell system 1; 101 having a fuel cell stack 2. The same reference numerals are used to designate the same or similar parts in FIGS. 1 and 2. An oxidizing agent, in particular air containing oxygen, is supplied to the fuel cell stack 2 in the form of a gas mass flow 4 via a gas conveying system 3.

The gas conveying system 3 in the fuel cell system 1 shown in FIG. 1 comprises a first compressor stage 5 and a second compressor stage 10. The first compressor stage 5 comprises two compressors 7, 8 connected in parallel and driven by an electric motor 6. An air filter 9 is upstream of the first compressor stage 5.

The second compressor stage 10 comprises a compressor 11 and a turbine 12. The compressor 11 is connected to the turbine 12 by a shaft 13 to drive it. To this end, the turbine 12 is powered by an exhaust mass flow 14 of the fuel cell stack 2.

In the fuel cell system 101 shown in FIG. 2, the gas conveying system 3 comprises a compressor 11 driven by an electric motor 6 and combined with a turbine 12 in the exhaust mass flow 14.

The turbine 12 is associated with a turbine bypass 15 with a turbine bypass valve 16. The fuel cell stack 2 is associated with a stack bypass 17 with a stack bypass valve 18. There is no post-stack valve downstream of the fuel cell stack 2.

A rectangle 21 indicates that the gas mass flow 4, in particular in the form of ambient air, is withdrawn from the surrounding environment. The exhaust mass flow 14 is supplied to the surrounding environment 21. In FIG. 1, a compressor bypass 22 with a compressor bypass valve 23 is associated with the compressor 11 of the second compressor stage 10.

A heat exchanger 19 embodied as an intercooler is upstream of the fuel cell stack 2. An optional heat exchanger 20, which is embodied as a gas-gas heat exchanger, advantageously serves to cool the incoming air and heat the exhaust mass flow.

The fuel cell stack 2 is connected between two shut off valves 102,103. The shut off valves 102,103 make it possible to avoid intrusion of oxygen into the cathode path of the stack after its shutdown. This can minimize undesirable aging in the stack. The shut off valves 102,103 do not have a regulation function.

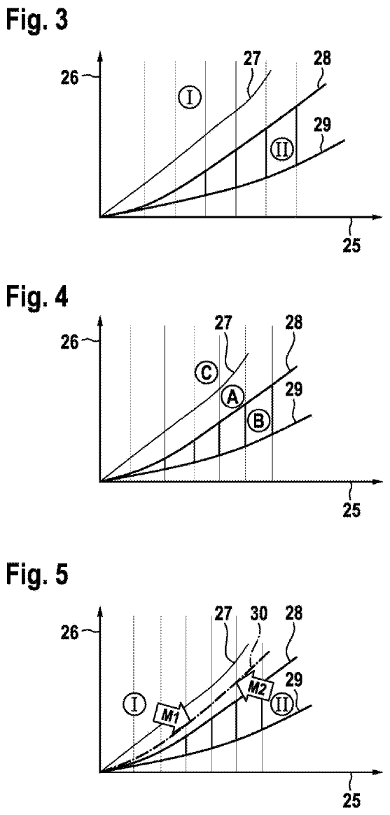

FIGS. 3 to 10 illustrate how a desired cathode mass flow rate and a desired cathode pressure can be adjusted or controlled in the fuel cell stack 2. The adjustment or control is carried out with the aid of the speed of the compressor 7 which can be varied by the electric motor 6, with the aid of the turbine bypass valve 16 and with the aid of the stack bypass valve 18.

By skillfully switching the operating strategy for cathode mass flow regulation and cathode pressure regulation, robust control or regulation is ensured that harnesses the full operating range of the fuel cell system while taking into account the limitations of air compression aggregates.

FIGS. 3 to 5 each show a Cartesian coordinate diagram, with an x-axis 25 and a y-axis 26. The cathode mass current is plotted in an appropriate unit of measure on the x-axis 25. The cathode pressure is plotted in an appropriate pressure unit, or pressure ratio, on the y-axis 26.

FIG. 4 corresponds to FIG. 2 in the German patent application DE 10 2019 216 624 A1. In FIG. 4, three operating ranges are denoted by capital letters A, B, and C. Pressure ratios and pressures can be converted into one another accordingly.

Three lines of separation 27, 28, 29 originate from the origin of the coordinate diagram in FIG. 4. The line of separation 27 represents the pumping limit of the compressor. Moreover, the line of separation 27 in FIG. 4 represents a boundary between the operating ranges A and C. The line of separation 28 represents a boundary between the operating ranges A and B. The line of separation 29 represents a lower boundary of the operating range B.

In FIGS. 3 and 5, a first operating range is designated I. A second operating range is designated II in FIGS. 3 and 5. The various operating ranges/strategies of the method for operating the gas conveying system or air system 3 in FIGS. 1,2 are shown in connection with the variables of the fuel cell stack, cathode mass flow and pressure to be controlled. It is important to distinguish whether the mass flow and the pressure are viewed from the fuel cell stack perspective or from the compressor perspective. The compressor may not operate to the left of the pumping limit 27 in FIGS. 3 to 5. Area I is largely enabled by the stack bypass. That is to say, a portion of the mass flow compressed by the compressor is fed past back the stack.

In FIGS. 3 and 5, the pumping limit 27 here is within the first operating range and must be considered for compressor operation, however this does not result in a direct switch in the operating strategy. Therefore, no direct switching of the operating strategy of the air system takes place near the pumping limit, which may be an advantage for the robustness of regulation.

FIGS. 4 and 5 show a comparison between the method proposed herein and the method disclosed in the German patent application DE 10 2019 216 624 A1. The new method expands the operating strategy/area C as indicated by an arrow symbolizing an action M1.

By changing the design of the air system, in particular the throttle characteristic of the air path downstream of the compressor, in particular the turbine, of the turbine bypass, operating range B is extended, as indicated by a further arrow, which symbolizes a measure M2. However, M2 is optional for the method and the operating strategies, that is, it is not a requirement for the method, but advantageous for efficiency and/or effectiveness.

With measure M1, the line of separation 28 in FIG. 5 results in a transition from operating strategy/operating range II to I, and vice versa. With both measures M1 and M2, the dotted characteristic curve 30 in FIG. 5 results in a transition from operating strategy/operating range II to I and vice versa.

Regulation in each of the two ranges can be implemented with or without pilot control. For example, a pilot-controlled PID controller may be used as a controller. Regulation in the two ranges and the controller switch were verified in the simulation.

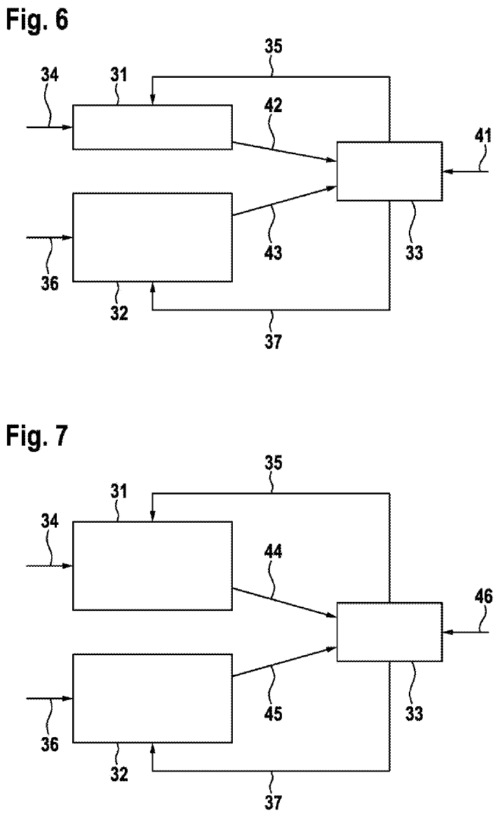

FIGS. 6 and 7 show controller structures for an application of the claimed method and also illustrate the corresponding switching between the two operating ranges.

The switch from the second range II to the first range I occurs when the requested cathode pressure is greater than the pressure achievable using the air system with the turbine bypass fully closed or with the aid of the specified pressures and mass flows, with a modified controller request.

The switching from the first region I to the second region II occurs when the requested cathode mass flow is greater than the achievable mass flow using the gas conveying system or the air system with the fully closed stack bypass valve or with the aid of the predetermined pressures and mass currents, with a modified controller request. For example, a pilot-controlled PID controller may be used as the controller.

FIGS. 6 and 7 show that the proposed control or controller structure with respect to the pressure level can be realized both as a pressure ratio and as a pressure (absolute pressure or relative pressure). FIG. 6 shows the control in the first operating range I. FIG. 7 shows the control in the second operating range II.

A rectangle 31 symbolizes pressure control. A rectangle 32 symbolizes mass flow control. A rectangle 33 symbolizes a control path, which is also referred to simply as a path. An arrow 34 symbolizes a target pressure. An arrow 35 symbolizes an actual pressure, which is also referred to simply as a pressure. An arrow 36 symbolizes a target mass flow. An arrow 37 symbolizes an actual mass flow, which is also referred to simply as a mass flow.

An arrow 41 in FIG. 6 illustrates that the turbine bypass (15 in FIGS. 1 and 2) is closed by way of the turbine bypass valve 16. An arrow 42 in FIG. 6 symbolizes a compressor speed, also referred to as a compressor rotational speed. An arrow 43 in FIG. 6 symbolizes the stack bypass (17 in FIGS. 1 and 2), or respectively, its flow area, which can be changed by means of the stack bypass valve 18.

An arrow 44 in FIG. 7 symbolizes the turbine bypass (15 in FIGS. 1 and 2) or respectively, its flow area, which can be changed by means of the turbine bypass valve 16. An arrow 45 in FIG. 7 symbolizes a compressor speed, also referred to as a compressor rotational speed. An arrow 46 in FIG. 7 illustrates that the stack bypass (17 in FIGS. 1 and 2) is closed by means of the stack bypass valve 18.

The target variables typically refer to the stack cathode path, that is, the pressure in and mass flow into the cathode path of the stack. The sizes for the compressor(s) are derived from the target sizes of the stack cathode path according to the operating range/operating strategy.

A switch from FIG. 6 to FIG. 7 is carried out when the stack bypass is fully closed and the mass flow would be too low, that is, the target mass flow could not be reached. In FIG. 7, pressure regulation 31 is carried out via the turbine bypass 44 and mass flow regulation 32 via the compressor speed 45.

A switch from FIG. 6 to FIG. 7 is carried out when the turbine bypass transitions to a completely closed state and the pressure would be too low, that is, the target pressure could not be reached. In FIG. 6, the pressure regulation 31 is carried out via the compressor speed 42 and the mass flow regulation 32 is carried out via the stack bypass 17.

In addition, a switch between the two ranges is carried out with the aid of the specified pressures and mass flows, for example in the event of a modified controller request. A modified controller request means that, when there is a jump in the target values, it is possible to read the operating range into which the system changes from the two target variables, i.e. target pressure and target mass flow.

Target mass flow is defined as the mass flow through the fuel cell stack 2. The corresponding target value is stored, for example, in a controller of the fuel cell system 1; 101. The mass flow through the stack, which is also referred to as the stack mass flow, results from the compressor mass flow provided by the compressor(s) 7,8, respectively, minus any bypass mass flow.

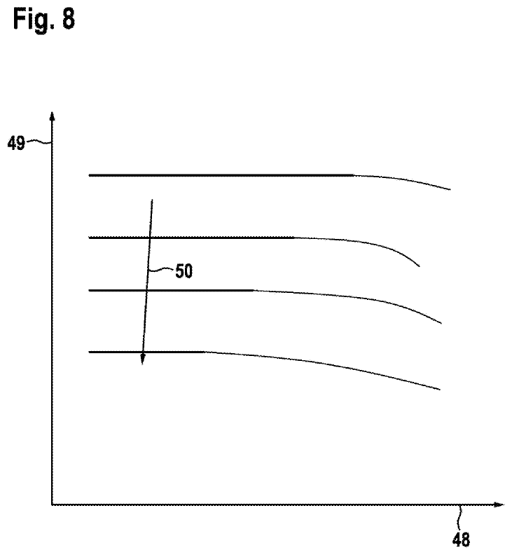

FIG. 8 shows a Cartesian coordinate diagram with an x-axis 48 and a y-axis 49. A mass flow of the compressor 7 is plotted on the x-axis 48 in FIG. 1 in a suitable unit. A pressure, or a pressure ratio, of the compressor 11 is plotted on the y-axis 49 in FIG. 1.

A vertical arrow 50 in FIG. 8 indicates that the speed of the compressor 11 in FIG. 1 is reduced in the second operating range II by opening the turbine bypass valve 16 in FIG. 1. Accordingly, the pressure or the pressure ratio of the compressor 7 in FIG. 1, respectively, becomes lower.

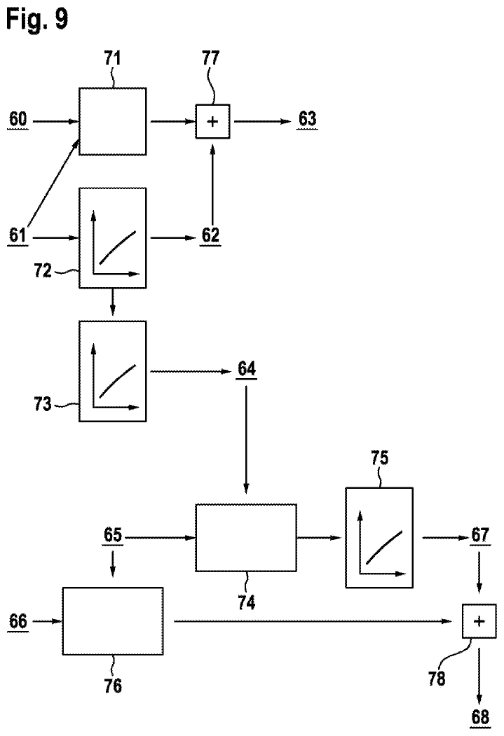

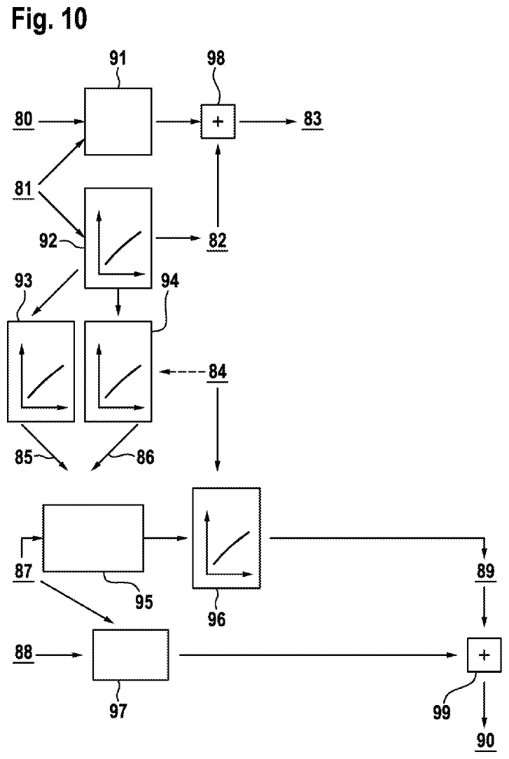

FIG. 9 shows a possible variant for a pilot-controlled PID controller for the first operating range I. FIG. 10 shows a possible variant for a pilot-controlled PID controller for the second operating range II.

In FIG. 9, rectangles 71 to 78 indicate controllers or control structures. Rectangle 71 symbolizes a PID controller. Rectangle 72 symbolizes a pilot control with a characteristic curve KL1. Rectangle 73 symbolizes a pilot control with a characteristic curve KL2. Rectangle 74 symbolizes a portion composed of 64 and 65. Rectangle 75 symbolizes a pilot control with a characteristic curve KL3. Rectangle 76 symbolizes a PID controller. The rectangles 77 and 78 symbolize additive links.

60 is an actual pressure. 61 is a target pressure. 62 and 63 are a target speed. 64 is a mass flow with the stack bypass valve closed. 65 is a target mass flow. 66 is an actual mass flow. 67 and 68 are valve positions of the stack bypass valve.

In FIG. 10, the rectangle 91 symbolizes a PID controller. The rectangle 92 symbolizes a pilot control with a characteristic curve KL4. The rectangle 93 symbolizes a pilot control with a characteristic curve KL6. The rectangle 94 symbolizes a pilot control with a characteristic curve KL5. The rectangle 95 symbolizes a portion of the pressure ratio of the compressor 11 in FIG. 1. The rectangle 96 symbolizes a pilot control with a characteristic curve KL7. The rectangle 97 symbolizes a PID controller. Rectangles 98 and 99 symbolize additive links.

80 symbolizes an actual mass flow. 81 symbolizes a target mass flow. 82 and 83 symbolize target speeds. 84 symbolizes a stack temperature. 85 symbolizes a pressure ratio of the compressor 7 in FIG. 1. 86 symbolizes a maximum pressure, or respectively, a maximum pressure ratio of the compressor 11 in FIG. 1. 87 symbolizes a target pressure, or respectively a target pressure ratio. 88 symbolizes an actual pressure, or an actual pressure ratio, respectively. 89 and 90 represent valve positions of the turbine bypass valve.

The claimed method may be used, on the one hand, in the operating strategy of vehicle engines with fuel cell systems. These may also be commercial vehicles. However, the claimed method may also be used in mobile applications, for example construction machines, with fuel cell systems.

1. A method of operating a fuel cell system (1;101), with a fuel cell stack (2), to which a mass gas flow (4) with an oxidation agent is supplied via a gas conveying system (3), wherein the gas conveying system (3) comprises at least one compressor (7,8;11) driven by an electric motor having a pumping limit (27) and at least one turbine (12), driven by an exhaust mass flow (14) of the fuel cell stack (2), which comprises a cathode path having a cathode mass flow and a cathode pressure, wherein the compressor (7,8;11) is configured to be driven at a variable speed, wherein the turbine (12) is associated with a turbine bypass (15) with a turbine bypass valve (16), wherein a stack bypass (17) is associated with the fuel cell stack (2) with a stack bypass valve (18), wherein the fuel cell system (1;101) is operated in different operating ranges, in which the cathode mass flow and the cathode pressure are controlled, the method comprising: maintaining the turbine bypass valve (16) closed at high pressure ratios and in a first operating range (I), in which the pumping limit (27) of the compressor (7,8;11) lies, controlling the cathode pressure via the speed of the compressor (7,8;11), and controlling the cathode mass flow via the stack bypass valve (18).

2. A method according to claim 1, wherein the stack bypass valve (18) remains closed in a second operating range (II) at low pressure ratios, wherein the cathode pressure is controlled via the turbine bypass valve (16), and wherein the cathode mass flow is controlled via the speed of the compressor (7,8;11).

3. A method according to claim 2, wherein when the requested cathode mass flow is greater than the achievable mass flow via the gas conveying system (3) with fully closed stack bypass valve (18), the system switches from the first to the second operating range.

4. A method according to claim 2, wherein the system switches from the second to the first operating range when the requested cathode pressure is greater than the achievable pressure by means of the gas conveying system (3) with the turbine bypass fully closed (15).

5. A method according to claim 2, wherein a hysteresis is used to switch between the two operating ranges.

6. A method according to claim 2, wherein the switching between the two operating ranges is triggered by a modified controller request.

7. A method according to claim 1, wherein a pilot-controlled PID controller is used.

8. A method according to claim 1, wherein no control valve in a main path is downstream of the fuel cell stack (2).

9. A method according to claim 1, wherein the fuel cell stack (2) is connected between two shut off valves (102,103).

10. A non-transitory, computer-readable medium containing instructions that when executed by a computer cause the computer control a fuel cell system (1;101), with a fuel cell stack (2), to which a mass gas flow (4) with an oxidation agent is supplied via a gas conveying system (3), wherein the gas conveying system (3) comprises at least one compressor (7,8;11) driven by an electric motor having a pumping limit (27) and at least one turbine (12), driven by an exhaust mass flow (14) of the fuel cell stack (2), which comprises a cathode path having a cathode mass flow and a cathode pressure, wherein the compressor (7,8;11) is configured to be driven at a variable speed, wherein the turbine (12) is associated with a turbine bypass (15) with a turbine bypass valve (16), wherein a stack bypass (17) is associated with the fuel cell stack (2) with a stack bypass valve (18), wherein the fuel cell system (1;101) is operated in different operating ranges, in which the cathode mass flow and the cathode pressure are controlled, by: maintaining the turbine bypass valve (16) closed at high pressure ratios and in a first operating range (I), in which the pumping limit (27) of the compressor (7,8;11) lies, controlling the cathode pressure via the speed of the compressor (7,8;11), and controlling the cathode mass flow via the stack bypass valve (18).
